(19) United States
(12) Patent Application Publication
(10) Pub. No.: US 2023/0033826 A1
(43) Pub. Date: Feb. 2, 2023

(54) Variable Tilting Blade Twin Turbine Windmill

(71) Applicant: Damodaran Ethiraj, T Nagar (IN)

(72) Inventor: Damodaran Ethiraj, T Nagar (IN)

(21) Appl. No.: 17/810,672

(22) Filed: Jul. 5, 2022

Related U.S. Application Data
(63) Continuation-in-part of application No. 17/444,183, filed on Jul. 31, 2021, now abandoned.

(51) Int. Cl. F03D 7/02; F03D 3/02

(52) U.S. Cl. CPC F03D 7/0224; F03D 3/02; F05B 2260/74; F05B 2260/79

(57) ABSTRACT

The variable tilting blade twin turbine windmill device is for capturing kinetic energy from the wind and is comprised of a shaft having a plurality of central hubs connectively attached, each central hub having a plurality of wind capture arms comprising a rotating wind capture blade having a capture surface and a slicing edge that are rotated by a rotating gear and drive gear combination connectively attached to said wind capture blades enabling a rotation of said wind capture blades wherein the wind capture blades are rotated between a blade-mode to capture the wind and a knife-mode to pass with less drag resistance through the air/wind thereby enabling an increase in the ability to capture more of the energy available in the wind stream.

### TECHNICAL FIELD OF THE INVENTION

This invention relates generally to a windmill having a wind turbine having a plurality of wind capture blades/arms to capture the wind for conversion into electrical energy by rotating a shaft in an electrical generator. This invention relates generally to fixed blade wind turbines, and more specifically to variable rotating blade wind turbines.

This invention relates specifically to a variable tilting blade twin turbine windmill in the form of a drive shaft driven by a plurality of wind capture blade sets (turbines) connectively attached to a shaft wherein said wind capture blades are rotated about their attached rods between a flat surface to capture the wind and an edge to slice through the wind for the purpose of increasing the effectiveness of wind capture by enabling the wind capture blades to be mechanically rotated to present a flat capture surface when facing a wind and mechanically rotated to slice through the wind when not in an ideal location to capture wind.

This invention relates specifically to a variable tilting blade twin turbine windmill in the form of a drive shaft driven by a plurality of wind capture blade sets (turbines) connectively attached to a shaft wherein said wind capture blades are rotated about their attached rods between a flat surface to capture the wind and an edge to slice through the wind for the purpose of increasing the effectiveness of wind capture by enabling the wind capture blades to be automatically rotated to present a flat capture surface when facing a wind and automatically rotated to slice through the wind when not in an ideal location to capture wind.

### BACKGROUND

Today there are windmills operating all over the world having fixed blade turbines. In order to increase the torque (force) of blade movement about the connected shaft long narrow blades with a bulge or widening at the bottom are used.

The nature of the fixed blade design results in wind drag which results in windmills being able to harvest and convert to electrical energy only about thirty to thirty-five percent of the available energy present in the wind.

In light of the foregoing prior art, there is a need for a rotating blade wind capture turbine to better collect/harvest the available energy present in the wind for conversion into electrical energy. Further, in light of the prior art, there is a need for a device with two or more rotating blade wind capture turbines to better collect/harvest/capture the available energy present in the wind for conversion into electrical energy.

### BRIEF SUMMARY OF THE INVENTION

According to a first aspect of the invention, there is a variable scooping blade windmill device for increasing an efficiency of capturing kinetic energy from a wind having a blowing direction comprising a rotating shaft having a left end opposing a right end, a first central hub connectively attached to said left end having a first plurality of at least three wind capture arms each comprising a wind capture blade having a capture surface and a slicing edge comprising an inner blade rod having a length and a first base end attached to said rotating shaft through said first central hub, an outer blade sleeve having a second base end wherein said outer blade sleeve is positioned to rotate axially about and contain and a majority of said inner blade rod and wherein said wind capture blade is attached lengthwise to said outer blade sleeve, and a drive motor having a drive gear connectively attached to said rotating shaft proximal to said first central hub positioned to enable a rotation of said outer blade sleeve with said drive gear enabling a rotation of said wind capture blade, a second central hub connectively attached to said right end having a second plurality of at least three wind capture arms wherein said wind capture arms comprise a scooping blade orientation comprising a rotation presenting said capture surface perpendicular to said wind blowing direction during a rotation of said windmill device when said wind capture blade is present in an upper half of a rotation cycle around said rotating shaft, and a slicing knife orientation comprising a rotation presenting said slicing edge parallel to said wind blowing direction during said rotation when said wind capture blade is present in a lower half said rotation cycle around said rotating shaft, a wind vane device having a wind direction vector, and a drive controller having a rotation control based on said wind direction vector, enabling a programmable automated clockwise rotation up to 90° of said wind capture blades about said inner blade shaft and a counterclockwise rotation up to 90° of said wind capture blades about said inner blade shaft depending upon said wind direction vector.

According to a second aspect of the invention, there is a variable scooping blade windmill device for increasing an efficiency of capturing kinetic energy from a wind further comprising at a first bevel gear operationally attached around said rotating drive shaft to enable rotation of a drive shaft having a second bevel gear operationally attached thereto.

According to a third aspect of the invention, there is a variable scooping blade windmill device for increasing an efficiency of capturing kinetic energy from a wind further comprising an electrical generator connectively attached to said drive shaft enabling a generation of electricity.

The invention will now be described, by way of example only, with reference to the accompanying drawings in which:

### BRIEF DESCRIPTION OF THE DRAWINGS

FIG. 1 is a perspective view of a variable tilting blade windmill having two central hubs at opposing ends of a rotating shaft each with three wind capture blades connectively attached according to the invention;

FIG. 2 is a cutaway view showing a variable tilting blade windmill having two central hubs at opposing ends of a rotating shaft each with three wind capture blades connectively attached according to the invention;

FIG. 3 is a side view of a central hub having three wind capture blades according to the invention; and

FIG. 4 is a perspective view of a shaft and central hub showing one wind capture blade being connectively attached according to the invention.

### DETAILED DESCRIPTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” et cetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Index of Labeled Features in Figures. Features are listed in numeric order by Figure in numeric order.

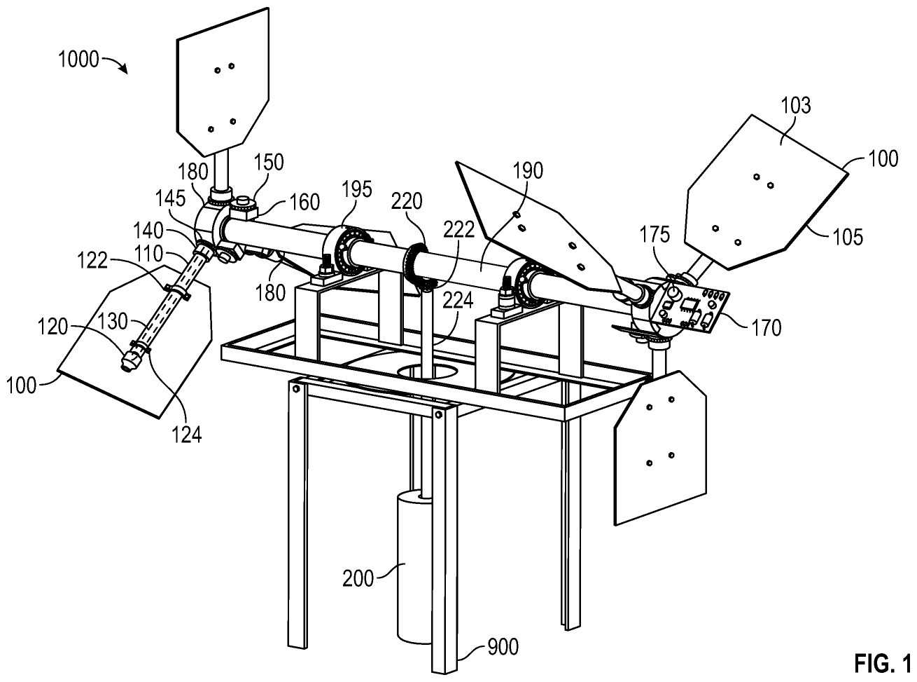

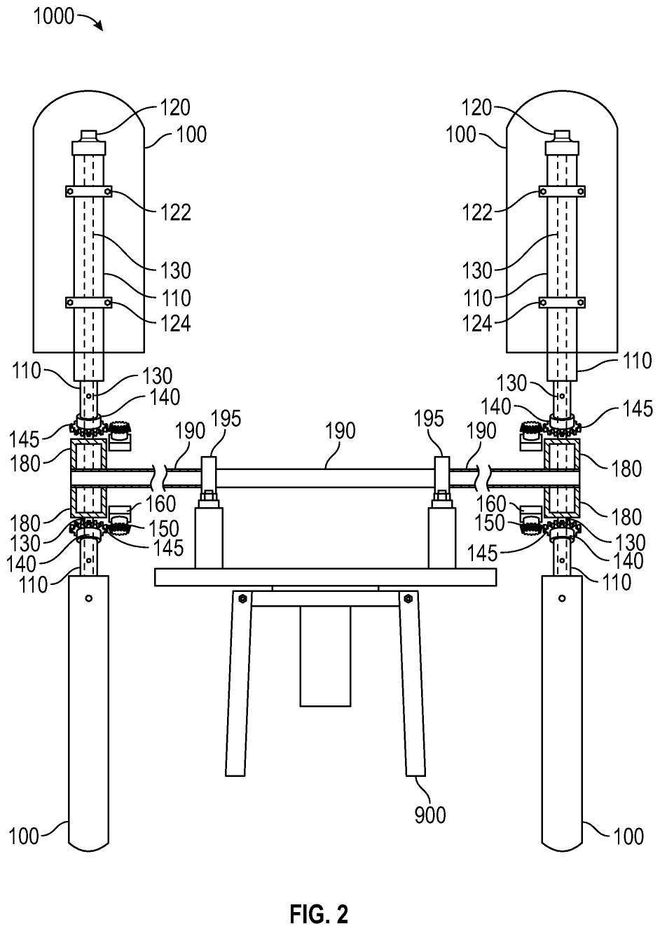

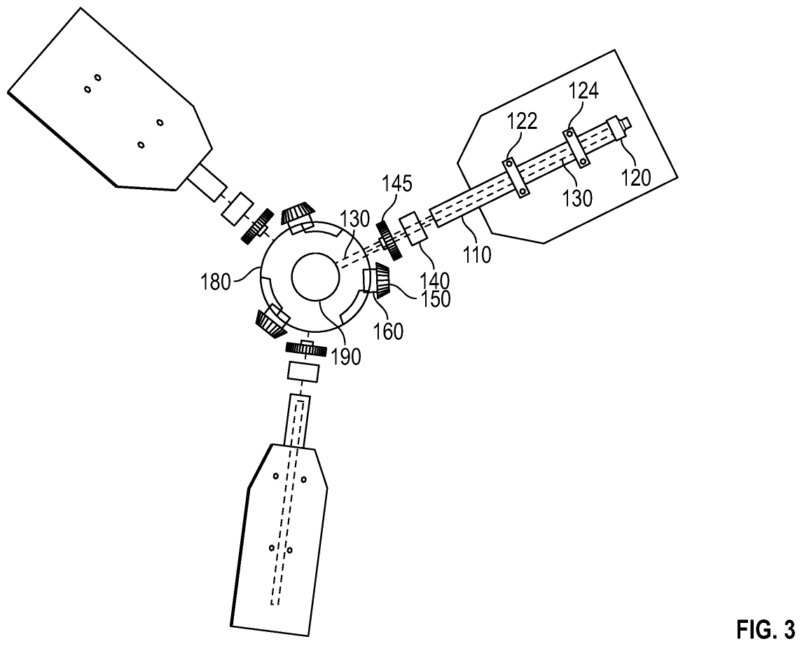

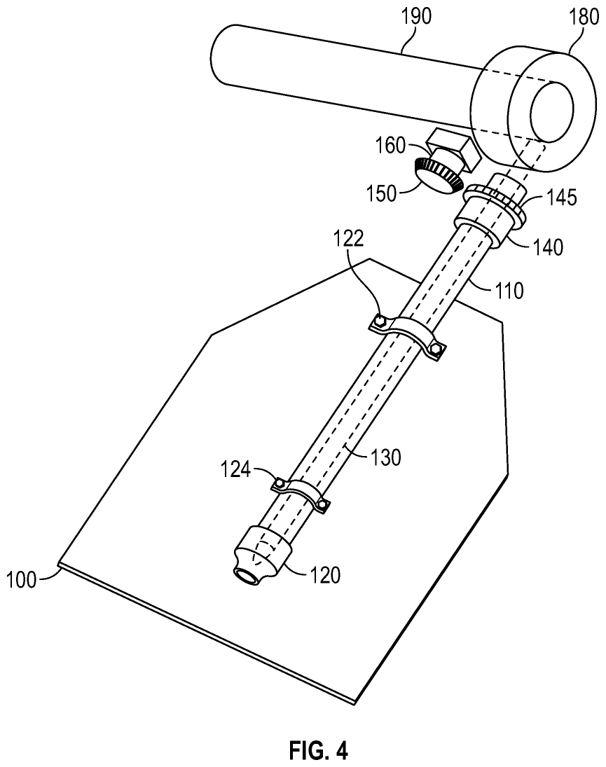

Referring to the Figures, there is shown in FIGS. 1, 2, 3, and 4 the following features:

Element 1000 which is a variable tilting blade twin turbine windmill device/apparatus.

Element 100 which is a wind capture blade.

Element 103 which is a wind capture surface of a wind capture blade.

Element 105 which is a wind slicing edge of a wind capture blade.

Element 110 which is an outer blade sleeve.

Element 120 which is a rolling bearing cap.

Element 122 which is a lower strap.

Element 124 which is an upper strap.

Element 130 which is an inner blade rod.

Element 140 which is a blade sleeve cup.

Element 145 which is a rotating gear.

Element 150 which is a drive gear.

Element 160 which is a drive gear drive motor.

Element 170 which is a drive controller.

Element 175 which is a wind direction device.

Element 180 which is central hub

Element 190 which is a shaft, or rotating shaft.

Element 195 which is a rolling bearing.

Element 200 which is a generator.

Element 220 which is a bevel gear in the shape of a ring surrounding the rotating shaft 190.

Element 222 which is a bevel gear attached to the top end of a drive shaft.

Element 224 which is a drive shaft.

Element 900 which is a windmill stand.

The manually operating embodiment of the device/apparatus of the present invention is made by assembling a plurality of wind capture blades about a plurality of central hubs to rotate a shaft. The wind capture blades comprise an assembly of an inner blade rod connectively attached to a shaft wherein said inner blade rod is enclosed with an outer blade sleeve attached to the end of the inner blade rod with a rotating gear or collar for rotating said outer blade sleeve about the longitudinal axis of said inner blade rod. Said outer blade sleeve is connectively attached to said wind capture blade with a lower strap and an upper strap. This enables the wind capture blade to be rotated about the longitudinal axis of said inner blade rod.

Controlling the rotation of the wind capture blades enables the device of the present invention to rotate between presenting a flat surface to capture the wind and an edge to slice through the wind for the purpose of increasing the effectiveness of wind capture by enabling the wind capture blades to be mechanically rotated to present a flat capture surface when facing a wind and mechanically rotated to slice through the wind when not in an ideal location to capture wind. The rotation of the wind capture blades by ninety degrees of arc/rotation from a full flat surface presentation to capture the wind in a blade-mode to a knife-mode wherein the wind capture blade is in an edge presentation to slice through, or pass through, the air/wind with less resistance results in less drag being imposed on a windmill by the fixed positioning of the blades consequently reducing the energy loss of the windmill system and thereby increasing the energy harvesting capacity of a windmill enabled with the device/apparatus of the present invention. Due to potential to deployment large blades geared motor tilting is provided for eliminating vibration.

Switching the wind capture blades of a windmill enabled with the device of the present invention between blade-mode and knife-mode can be enabled manually with a tilting lever to mechanically rotate said wind capture blade in blade-mode presentation over a blade guide ring into knife-mode presentation and then rotate said wind capture blade back to blade-mode when said wind capture blade pass over the end of the blade guide ring. Rotation is the wind capture blade is maintained in the correct position by the installation (connective attachment) of a plurality of blade guide posts positioned around the base end of the wind capture blade proximal to the shaft or attachment end of the inner blade rod to maximize the capture of a wind for conversion to electrical energy by rotating the shaft/drive shaft through an electrical generator.

Switching the wind capture blades of a windmill enabled with the device of the present invention between blade-mode and knife-mode can be enabled automatically with the installation of wind direction device to determine the wind direction vector which is then used by an electronic drive controller having rotational control of a plurality of drive motors connectively attached to rotate the rotation and drive gears enabling the movement of said wind capture blades between blade-mode and knife-mode at any rotational position required to maximize the capture of a wind for conversion to electrical energy by rotating the shaft/drive shaft through an electrical generator.

The wind capture blades of the present invention are best embodied wherein the shape of the blade is designed/constructed in a rectangular, flat and broad (wide) configuration/size/shape to maximize surface area presentation in blade-mode, and minimize the surface area in knife-mode. Manual or automated gears and/or the combination of physical limiting controls presented by a tilting lever, blade guide ring, and blade guide posts can be used to control whether and when/wherein/during the rotation of the wind capture blades about the shaft occurs to place the wind capture blades into blade-mode or knife-mode.

Configuring the device of the present invention to present blade-mode during the primary wind front half of the wind capture blades rotation around the shaft and to present knife-mode during the other half of the rotation has the impact of a windmill turbine that has decreased drag during the knife-mode blade presentation thereby resulting in a corresponding increase of capacity of said windmill to capture or harvest energy from the wind. With the wind capture blades in blade-mode they are forced by the wind with less resistance presented by the blades in knife-mode resulting in less energy loss into the windmill as a system from wind capture blades not present in the wind stream when not in a location of rotation to be useful for capturing wind and thereby resulting in more energy transfer (harvesting) of energy available in the wind.

Using the device of the present invention is best made by determining the wind direction and resulting primary wind force profile presented to a windmill by the wind, and then configuring the blades to be in blade-mode for the primary wind force profile half of the turbine's rotation and in knife-mode for the part(s) not as useful for collecting wind energy. The transition between blade-mode and knife-mode can occur at any or multiple locations during a full rotation of the turbine. The present preferred embodiment uses about 120° arc for blade-mode and 240 arc for knife-mode.

The improved energy transfer from windmill to generator resulting from the decrease in drag resulting from the blades in knife-mode presenting minimum wind resistance and therefore less energy consumption to rotate a turbine is apparent. However, the present invention offers the capacity to enable the wind capture blades to scoop or cup the wind during transition from blade-mode to knife-mode and during transition from knife-mode to blade-mode creating a rotating scoop with the wind capture blade resulting in an increase in the energy capture from wind and resulting energy conversion into electricity.

The rotating blade wind turbines created to embody the present invention offer the advantage of less drag from the blades in knife-mode resulting in less consumption of energy by the turbine resulting in more energy transfer into the shaft and the resulting increase in energy harvest from the wind. Another advantage of the present invention is the ability to configure the presentation (blade-mode or knife-mode), timing, and location of change in wind capture blade orientation (blade-mode or knife-mode) for each wind capture blade.

When embodied for automatic rotation, there is the further advantage of the present invention to scoop, cup, or grab more air resulting in more energy transfer from wind to wind capture blade and its corresponding increase in energy transfer from the wind into electrical energy with a windmill enabled with the device of the present invention. The capacity to configure the arc length, timing, and duration for the wind capture blade to stay in blade-mode permits an operator to adjust the windmill to maximize blade-mode presentation to keep the wind capture blades in blade-mode for at least that half of the turbine rotation where the wind is its strongest within the wind profile offer to the windmill.

The half to three-quarters of the rotation of the turbine that has the wind capture blades in blade-mode can even be adjusted to feather (delicately transition into) blade-mode into knife-mode and to feather knife-mode into blade mode. Feathering or easing (longer time to rotate) between blade modes allows a windmill turbine to be configured to scoop, cup, or grab the wind at the points where the wind capture blades transition between modes similar to a passenger in a automobile flying their cupped hand out an open car window.

In a preferred embodiment of the present invention, there is a variable scooping blade windmill device for increasing an efficiency of capturing kinetic energy from a wind having a blowing direction comprising a rotating shaft having a left end opposing a right end, a first central hub connectively attached to said left end having a first plurality of at least three wind capture arms each comprising a wind capture blade having a capture surface and a slicing edge comprising an inner blade rod having a length and a first base end attached to said rotating shaft through said first central hub, an outer blade sleeve having a second base end wherein said outer blade sleeve is positioned to rotate axially about and contain and a majority of said inner blade rod and wherein said wind capture blade is attached lengthwise to said outer blade sleeve, and a drive motor having a drive gear connectively attached to said rotating shaft proximal to said first central hub positioned to enable a rotation of said outer blade sleeve with said drive gear enabling a rotation of said wind capture blade, a second central hub connectively attached to said right end having a second plurality of at least three wind capture arms wherein said wind capture arms comprise a scooping blade orientation comprising a rotation presenting said capture surface perpendicular to said wind blowing direction during a rotation of said windmill device when said wind capture blade is present in an upper half of a rotation cycle around said rotating shaft, and a slicing knife orientation comprising a rotation presenting said slicing edge parallel to said wind blowing direction during said rotation when said wind capture blade is present in a lower half said rotation cycle around said rotating shaft, a wind vane device having a wind direction vector, and a drive controller having a rotation control based on said wind direction vector, enabling a programmable automated clockwise rotation up to 90° of said wind capture blades about said inner blade shaft and a counterclockwise rotation up to 90° of said wind capture blades about said inner blade shaft depending upon said wind direction vector.

In an alternate embodiment of the present invention, there is a variable scooping blade windmill device further comprising at a first bevel gear operationally attached around said rotating drive shaft to enable rotation of a drive shaft having a second bevel gear operationally attached thereto.

In an alternate embodiment of the present invention, there is a variable scooping blade windmill device further comprising an electrical generator connectively attached to said drive shaft enabling a generation of electricity.

In an example embodiment of the present invention, there is a variable tilting blade windmill device for capturing kinetic energy from a wind comprising a shaft having a first end and a second end wherein said second end is connectively attached through a rolling bearing to a drive shaft, a central hub connectively attached to said first end having a plurality of wind capture arms comprising a wind capture blade having a capture surface and a slicing edge comprising an inner blade rod having a base end connectively attached to said shaft proximal to said central hub, an outer blade sleeve enclosing a majority of the length of said inner blade rod having a rotating gear connectively attached to said wind capture blade, a drive gear connectively attached to said shaft at a right angle enabling a rotation of said wind capture blade.

In an example embodiment of the present invention, there is a variable tilting blade windmill device for capturing kinetic energy from a wind comprising a shaft having a first free end and a second free end connectively attached proximal to the mid-point along its length through a rolling bearing to a drive shaft, a first central hub connectively attached to said first free end having a plurality of wind capture arms comprising a wind capture blade having a capture surface and a slicing edge comprising an inner blade rod having a base end connectively attached to said shaft proximal to said central hub, an outer blade sleeve enclosing a majority of the length of said inner blade rod having a rotating gear connectively attached to said wind capture blade, a drive gear connectively attached to said shaft at a right angle enabling a rotation of said wind capture blade a second central hub connectively attached to said second free end having a plurality of wind capture arms comprising a wind capture blade having a capture surface and a slicing edge comprising an inner blade rod having a base end connectively attached to said shaft proximal to said central hub, an outer blade sleeve enclosing a majority of the length of said inner blade rod connectively attached to said wind capture blade, and a drive gear connectively attached to said shaft at a right angle enabling a rotation of said wind capture blade.

In an example alternate embodiment, there is a variable tilting blade windmill device for capturing kinetic energy from a wind wherein said drive gear is connectively attached to said central hub at a right angle enabling a rotation of said outer blade sleeve.

In an example alternate embodiment, there is a variable tilting blade windmill device for capturing kinetic energy from a wind wherein said wind capture blades have a push orientation positioned wherein said capture surface is positioned facing an on-coming wind and are rotated by said wind through a rotation about said shaft of between 120° and 240° and are then rotated 90° to present said slicing edge in the direction of said wind enabling said wind capture blade to present a minimized aerodynamic profile in the direction of said wind.

In an example alternate embodiment, there is a variable tilting blade windmill device for capturing kinetic energy from a wind wherein said device is further comprising a tilting lever for mechanically rotating said drive gear connectively attached to said central hub configured to enable a rotation up to 90° of said wind capture blades about said inner blade shaft upon rotation of said central hub, a blade guide ring positioned to surround up to 120° of arc proximal to said shaft enabling a rotation of 90° of said wind capture blades about said inner blade shaft upon said wind capture blades passing over said blade guide ring, and a plurality of blade guide posts positioned to stop a rotation of each wind capture blade about said inner blade shaft upon rotation of said wind capture blades.

In an example alternate embodiment, there is a variable tilting blade windmill device for capturing kinetic energy from a wind further comprising a wind vane device having a wind direction vector, a drive controller having a rotation control based on said wind direction vector, and a plurality of drive motors operationally attached to said drive controller to operate said drive gears enabling an programmable automated clockwise rotation up to 90° of said wind capture blades about said inner blade shaft and a counterclockwise rotation up to 90° of said wind capture blades about said inner blade shaft depending upon said wind direction vector.

In an example alternate embodiment, there is a variable tilting blade windmill device for capturing kinetic energy from a wind further comprising an electrical generator connectively attached to said drive shaft enabling a generation of electricity.

The present invention offers several important improvements and increases in efficiency of energy capture from the wind by enabling several new ways to use the rotation of the wind capture blades. First. to offer less resistance in a slicing knife orientation of the wind capture blades thereby increasing efficiency of movement with less resistance from the moving wind. Second, to offer greater wind capture in a scooping blade orientation of the wind capture blades thereby increasing the amount of energy collect from the moving wind to rotate the turbine.

An advantage of the present invention is decreased wind capture blade resistance resulting in greater energy transfer and/or conversion into electrical energy. The wind slicing orientation of the wind capture blades positions the slicing surface to present the thinnest edge to the moving wind thereby decreasing the resistance to movement and enabling more efficient energy transfer from the turbine—plurality of wind capture blades.

An advantage of the present invention is increased wind energy capture by controlling the rotation of the wind capture blades resulting in greater energy transfer and/or conversion into electrical energy. The scooping motion from the rotation of the wind capture blades is an air cupping motion, like that of hand out a car window scooping or cupping the air to float the arm, wherein the moving air is cupped or scooped by the rotation of the wind capture surface to enable increased catching of the moving wind. This scooping or cupping of the wind from rotation of the wind capture blades serves to increase the amount of force captured from the wind consequently resulting in greater energy transfer and/or conversion into electrical energy.

A further advantage of the present invention is the addition of a second turbine attached to the same shaft as the first turbine at its other end which results in doubling of the harvest of the moving air leading to increased electricity generation.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A variable scooping blade windmill device for increasing an efficiency of capturing kinetic energy from a wind having a blowing direction comprising
a rotating shaft having a left end opposing a right end,
a first central hub connectively attached to said left end having a first plurality of at least three wind capture arms each comprising
a wind capture blade having a capture surface and a slicing edge comprising
an inner blade rod having a length and a first base end attached to said rotating shaft through said first central hub,
an outer blade sleeve having a second base end wherein said outer blade sleeve is positioned to rotate axially about and contain a majority of said inner blade rod and wherein said wind capture blade is attached lengthwise to said outer blade sleeve, and
a drive motor having a drive gear connectively attached to said rotating shaft proximal to said first central hub positioned to enable a rotation of said outer blade sleeve with said drive gear enabling a rotation of said wind capture blade,
a second central hub connectively attached to said right end having a second plurality of at least three wind capture arms
wherein said wind capture arms comprise
a scooping blade orientation comprising a rotation presenting said capture surface perpendicular to said wind blowing direction during a rotation of said variable scooping blade windmill device when said wind capture blade is present in an upper half of a rotation cycle around said rotating shaft, and
a slicing knife orientation comprising a rotation presenting said slicing edge parallel to said wind blowing direction during said rotation when said wind capture blade is present in a lower half said rotation cycle around said rotating shaft,
a wind vane device having a wind direction vector, and
a drive controller having a rotation control based on said wind direction vector, enabling a programmable automated clockwise rotation up to 90° of said wind capture blades about an inner blade shaft and a counterclockwise rotation up to 90° of said wind capture blades about said inner blade shaft depending upon said wind direction vector.

2. The variable scooping blade windmill device of claim 1 further comprising at a first bevel gear operationally attached around a rotating drive shaft to enable rotation of a drive shaft having a second bevel gear operationally attached thereto.

3. The variable scooping blade windmill device of claim 2 further comprising an electrical generator connectively attached to said drive shaft enabling a generation of electricity.
